(19) United States
(12) Patent Application Publication
(10) Pub. No.: US 2024/0192938 A1
(43) Pub. Date: Jun. 13, 2024

(54) QUANTUM AND NON-QUANTUM SOURCE CODE TRANSLATION

(71) Applicant: International Business Machines Corporation, Armonk, NY (US)

(72) Inventors: Juan Cruz Benito, Salamanca (ES); Ismael Faro Sertage, Chappaqua, NY (US); Francisco Jose Martin Fernandez, Ridgefield, CT (US)

(21) Appl. No.: 18/165,591

(22) Filed: Feb. 7, 2023

(30) Foreign Application Priority Data
Dec. 7, 2022 (EP) 22383192.6

(51) Int. Cl. G06F 8/51; G06F 8/33; G06N 10/60

(52) U.S. Cl. CPC G06F 8/51; G06F 8/33; G06N 10/60

(57) ABSTRACT

One or more systems, devices, computer program products and/or computer-implemented methods of use provided herein relate to a process to port code while adapting the code for a configuration of a target system. A system can comprise a memory that stores computer executable components, and a processor that executes the computer executable components stored in the memory, wherein the computer executable components can comprise an identification component that identifies a configuration of a target system on which a translated source code is to be executed, and a translation component that translates, based on a constraint defining the configuration, an original source code into the translated source code. In one or more embodiments, the translated source code can comprise a code language not comprised by the original source code and/or can be modified to align with the constraint, which can be of a hardware and/or software configuration.

### TECHNICAL FIELD

The present disclosure relates to translating of source code, and more specifically to adapting the source code for use with a target system based on a configuration of the target system.

### BACKGROUND

With current advances in software engineering, source code for execution of software and/or hardware components can be written in a plethora of languages and can use various libraries and/or syntax of such libraries.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments described herein, systems, computer-implemented methods, apparatuses and/or computer program products can provide a process to port source code while translating the source code for use with a configuration of a target system. As used herein, such source code can refer to any code for use in executing a hardware and/or software component, and can comprise code at various levels of abstraction and/or granularity of such hardware and/or software component.

In accordance with an embodiment, a system can comprise a memory that stores computer executable components, and a processor that executes the computer executable components stored in the memory, wherein the computer executable components can comprise an identification component that identifies a configuration of a target system on which a translated source code is to be executed, and a translation component that translates, based on a constraint defining the configuration, an original source code into the translated source code.

An advantage of the above-indicated system can be allowing for various source code languages, versions, syntax and/or libraries to be used in connection with a same target system. Additionally, and/or alternatively, where the translation comprises modification of the source code, such modification can reduce execution cost, such as time, power usage and/or memory usage, associated with execution of a hardware and/or software component of the target system.

In accordance with another embodiment, a computer-implemented method can comprise identifying, by a system operatively coupled to a processor, a configuration of a target system on which a translated source code is to be executed, and translating, by the system, based on a constraint defining the configuration, an original source code into the translated source code.

An advantage of the above-indicated method can be allowing for various source code languages, versions, syntax and/or libraries to be used in connection with a same target system. Additionally, and/or alternatively, where the translation comprises modification of the source code, such modification can reduce execution cost, such as time, power usage and/or memory usage, associated with execution of a hardware and/or software component of the target system.

In accordance with yet another embodiment, a computer program product providing a process to automatically port source code can comprise a computer readable storage medium having program instructions embodied therewith, the program instructions executable by a processor to cause the processor to identify, by the processor, a configuration of a target system on which a translated source code is to be executed, and translate, by the processor, based on a constraint defining the configuration, an original source code into the translated source code.

An advantage of the above-indicated computer program product can be allowing for various source code languages, versions, syntax and/or libraries to be used in connection with a same target system. Additionally, and/or alternatively, where the translation comprises modification of the source code, such modification can reduce execution cost, such as time, power usage and/or memory usage, associated with execution of a hardware and/or software component of the target system.

In one or more embodiments of the above-indicated system, computer-implemented method and/or computer program product, an artificial intelligence model can be employed by the translation component to translate the original source code to the translated source code. An advantage of such one or more embodiments can be automatic translation, based on learned languages, code libraries, code syntax, configurations and/or constraints defining configurations, of the original source code into a translated source code usable to execute a hardware and/or software component (e.g., having the configuration) of the target system.

In one or more embodiments of the above-indicated system, computer-implemented method and/or computer program product, the translation can comprise modifying the original source code to align with the constraint of the configuration. An advantage of such one or more embodiments can be transformation of the source code in connection with porting of the source code, wherein the transformation can enable the source code not only to function in connection with the target system, but to function better with the target system than a non-modified translated source code alone—that is, better than a merely translated source code without modification.

In one or more embodiments, the modification can allow for a reduced cost of execution of a hardware or software component (e.g., having the configuration) of the target system. As used herein, cost can refer to time, power usage, memory usage, and/or the like. With reference to quantum source code in connection with a quantum system, cost can additionally and/or alternatively refer to more efficient use of qubit coherency time, less use of qubit coherency time, and/or the like.

Further, in connection with the translated source code being translated quantum source code in connection with a quantum system, one or more additional advantages of the one or more embodiments can be an ability to alter qubit coupling mapping, alter qubits to be employed, select qubits having varying performances, alter (e.g., transform) a quantum circuit (e.g., one or more quantum gates thereof), and/or the like.

### DESCRIPTION OF THE DRAWINGS

FIG. 1 illustrates a block diagram of an example, non-limiting system that can provide a process to port and translate a source code, in accordance with one or more embodiments described herein.

FIG. 2 illustrates a block diagram of another example, non-limiting system that can provide a process to port and translate a source code, in accordance with one or more embodiments described herein.

FIG. 3 illustrates a set of constraints and translation aspects, in accordance with one or more embodiments described herein.

FIG. 4 illustrates a block diagram of an example, non-limiting system comprising the source code translating system of FIG. 2 in connection with a quantum system, in accordance with one or more embodiments described herein.

FIG. 5 illustrates a block flow diagram illustrating use of a source code translating system as described herein, in connection with a quantum system, in accordance with one or more embodiments described herein.

FIG. 6 depicts an exemplary translation of an original source code in one language to a translated source code in another language, in accordance with one or more embodiments described herein.

FIG. 7 illustrates an exemplary translation of an original source code in one language to a translated source code in the same language, in accordance with one or more embodiments described herein.

FIG. 8 illustrates a flow diagram of one or more processes that can be performed by and/or in connection with a source code translating system, in accordance with one or more embodiments described herein.

FIG. 9 illustrates a flow diagram of one or more processes that can be performed by and/or in connection with a source code translating system in relation to a quantum system, in accordance with one or more embodiments described herein.

FIG. 10 illustrates a block diagram of example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Generally, the translation of a source code from an original source code to a translated source code can be performed by one or more embodiments. This translation can comprise use of one or more source code languages, code libraries, code syntax and/or the like in the translated source code that were not present in the original source code. The translation, additionally and/or alternatively, can comprise modification of the original source code, such as tailoring the original source code to align with a configuration (e.g., hardware configuration and/or software configuration) of a target system on which the translated source code is expected to be executed.

The target system can comprise the configuration, which configuration can be defined by one or more constraints of the configuration. By identifying one or more constraints of the configuration of the target system, prior to the translation, the translation can be at least partially based on the one or more constraints. In this way, the translation can be efficient and can aid in preparing the original source code, as a translated source code, for efficient and high performance execution on the target system. It follows that the one or more embodiments described herein can enable improved performance of the target system executing the translated source code, such as improved performance of a target quantum system during operation of a quantum circuit at one or more physical qubits of the target quantum system. That is, relative to a target quantum system, the one or more embodiments herein can enable improved performance of quantum algorithms on near term quantum systems limited by coherence times and/or unacceptable error rates of circuits with high quantum circuit depth, thus improving the operation of such quantum circuits.

Indeed, conventional techniques do not account for such constraints, and thus do not provide such tailoring. Differently, the one or more embodiments described herein can learn, be trained, and/or employ one or more knowledge databases to determine constraints of a target system, which can be a classical system and/or a quantum system. The source code translated can be any code for use in executing a hardware and/or software component of the target system, and can comprise code at various levels of abstraction and/or granularity of such hardware and/or software component.

In one or more embodiments, an analytical model, such as an artificial intelligence model, can employ neural machine translation (NMT) to translate the original source code. As used herein, NMT can refer to an approach to machine translation that can use an artificial neural network to predict a likelihood of a sequence of words, such as modeling entire sentences in a single integrated model. Relative to the one or more embodiments described herein, NMT and machine learning (ML) can be employed to adapt an original source code, as part of its translation, for a particular syntax, source code words, full source code library, vender term usage and/or the like.

Further, the one or more embodiments described herein can translate original quantum source code to translated quantum source code. As used herein, quantum source code can refer to any code for controlling a hardware and/or software component of a quantum system. In one or more embodiments, the original quantum source code can range between using high level abstractions to assembly level or pulse level.

The aforementioned NMT and ML can be employed to adapt an original quantum source code, as part of its translation, for particular qubit performance metrics, qubit couplings, electronics mappings and/or the like. This can allow for better performance and/or measurement results from a hardware and/or software component of the target quantum system on which the translated quantum source code is to be executed.

In one or more embodiments, an analytical model, such as the one previously mentioned, can be employed to automatically port a user entity's original source code (e.g., classical or quantum source code) to a target system in a translated form, which translated form can include one or more modifications for better use, performance, cost and/or the like on the target system. In this way, where code libraries and languages continue to change, evolve, and/or be written, a user entity can still obtain execution of an original source code, even without knowing and/or being trained on all particulars of source code used by a target system.

As used herein, the term “cost” can refer to money, power, memory, bandwidth, time, manpower and/or the like.

As used herein, the terms “entity”, “requesting entity”, and “user entity” can refer to a machine, device, component, hardware, software, smart device and/or human.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

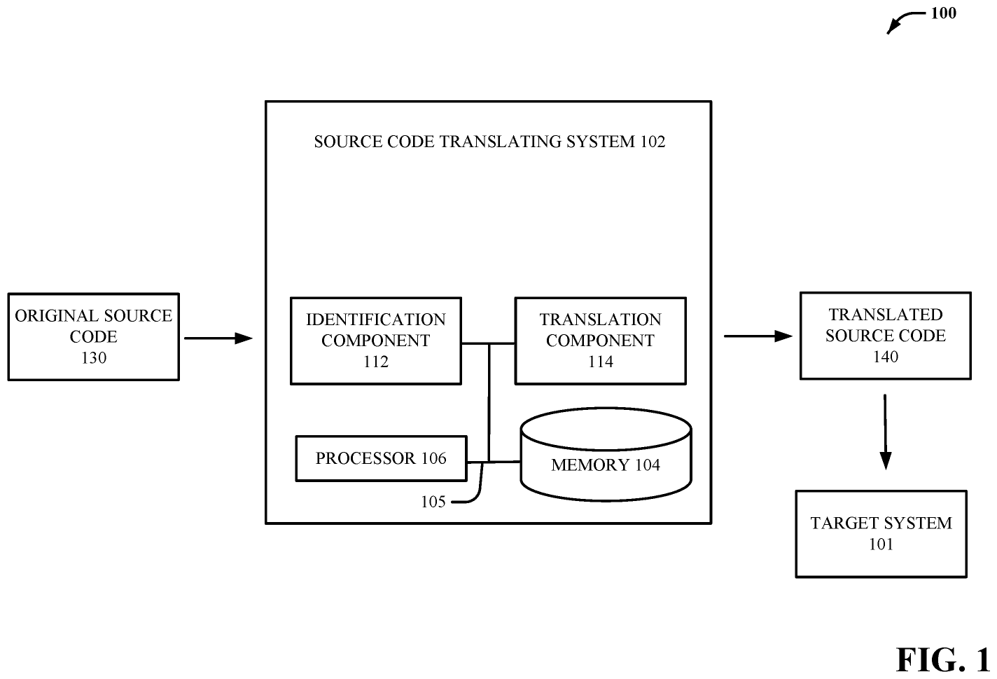

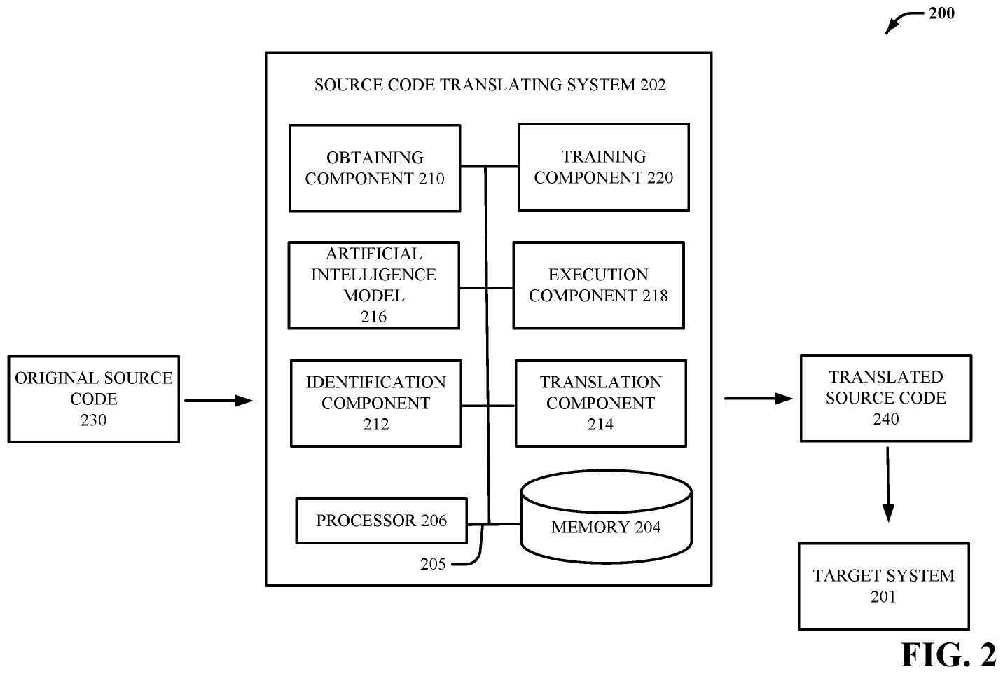

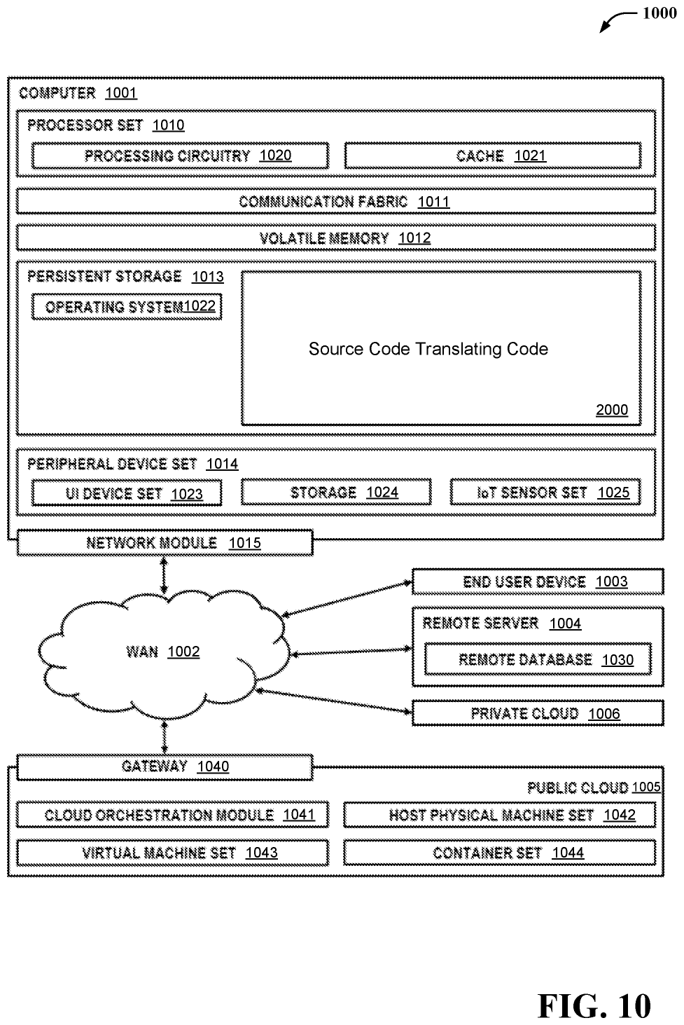

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems 100, 200 and/or 400 illustrated at FIGS. 1, 2 and/or 4, and/or systems thereof, can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1, 2 and/or 4 and/or with other figures described herein.

Turning now in particular to one or more figures, and first to FIG. 1, the figure illustrates a block diagram of an example, non-limiting system 100 that can facilitate source code porting and translation, in accordance with one or more embodiments described herein.

The non-limiting system 100 can comprise a source code translating system 102, which can be associated with a cloud computing environment. The source code translating system 102 can comprise one or more components, such as a memory 104, processor 106, bus 105, identification component 112 and/or translation component. Generally, source code translating system 102, and thus non-limiting system 100, can facilitate use of an original source code 130 with a target system 101, by employing a translation of the original source code 130.

The identification component 112 can identify a configuration of a target system 101 on which a translated source code 140 is to be executed. The translation component 114 can translate, based on a constraint defining the configuration, an original source code 130 into the translated source code 140.

Turning next to FIG. 2, a non-limiting system 200 is illustrated that can comprise a source code translating system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The source code translating system 202 can be associated with, such as accessible via, a cloud computing environment.

The source code translating system 202 can comprise a plurality of components. The components can comprise a memory 204, processor 206, bus 205, obtaining component 210, identification component 212, translation component 214, artificial intelligence model 216, execution component 218 and/or training component 220.

Generally, the source code translating system 202 can obtain an original source code and/or one or more configurations, such as defined by one or more constraints, of a target system 201 on which the original source code 230 is desired to be run. The source code translating system 202 can generally translate the original source code 230 into a translated source code 240 that can be executed on the target system.

Discussion first turns briefly to the processor 206, memory 204 and bus 205 of the source code translating system 202. For example, in one or more embodiments, the source code translating system 202 can comprise the processor 206 (e.g., computer processing unit, microprocessor, classical processor, quantum processor and/or like processor). In one or more embodiments, a component associated with source code translating system 202, as described herein with or without reference to the one or more figures of the one or more embodiments, can comprise one or more computer and/or machine readable, writable and/or executable components and/or instructions that can be executed by processor 206 to provide performance of one or more processes defined by such component(s) and/or instruction(s). In one or more embodiments, the processor 206 can comprise the obtaining component 210, identification component 212, translation component 214, artificial intelligence model 216, execution component 218 and/or training component 220.

In one or more embodiments, the source code translating system 202 can comprise the computer-readable memory 204 that can be operably connected to the processor 206. The memory 204 can store computer-executable instructions that, upon execution by the processor 206, can cause the processor 206 and/or one or more other components of the source code translating system 202 (e.g., obtaining component 210, identification component 212, translation component 214, artificial intelligence model 216, execution component 218 and/or training component 220) to perform one or more actions. In one or more embodiments, the memory 204 can store computer-executable components (e.g., obtaining component 210, identification component 212, translation component 214, artificial intelligence model 216, execution component 218 and/or training component 220).

The source code translating system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the source code translating system 202 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical and/or quantum computing devices, communication devices and/or like devices), such as via a network. In one or more embodiments, one or more of the components of the source code translating system 202 and/or of the non-limiting system 200 can reside in the cloud, and/or can reside locally in a local computing environment (e.g., at a specified location(s)).

In addition to the processor 206 and/or memory 204 described above, the source code translating system 202 can comprise one or more computer and/or machine readable, writable and/or executable components and/or instructions that, when executed by processor 206, can provide performance of one or more operations defined by such component(s) and/or instruction(s).

Turning now to the additional components of the source code translating system 202 (e.g., obtaining component 210, identification component 212, translation component 214, artificial intelligence model 216, execution component 218 and/or training component 220), generally, the source code translating system 202 can obtain, analyze and translate source code for execution on a target system.

Turning first to the obtaining component 210, this component can identify, search, receive, transfer and/or otherwise obtain the original source code 230 that is desired to be translated. The original source code 230 can have a different code language or syntax and/or use a different code library than source code that is employed by a target system 201 on which it is desired to execute the original source code 230 (e.g., translated version of the original source code).

Turning next to the identification component 212, this component can identify, search, receive, transfer and/or otherwise obtain one or more constraints defining a configuration of the target system 201. The configuration can be a software configuration and/or a hardware configuration, such as of a software component and/or hardware component of the target system 201. The constraints can be identified at a location internal to and/or external to the source code translating system 202. For example, one or more knowledge bases can be communicatively coupled to the source code translating system 202 and can comprise one or more constraints for being employed by the source code translating system 202. In one or more embodiments, one or more configurations and/or one or more constraints can be selected by a user entity, such as being requested when providing the original source code 230 for translation.

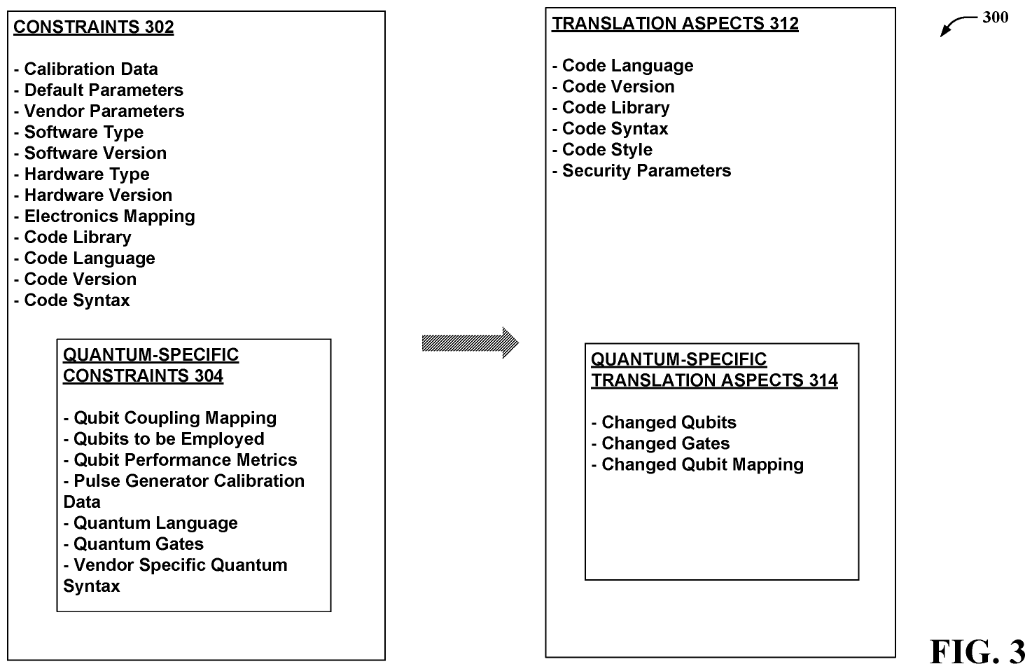

Turning briefly to FIG. 3, and still referring to FIG. 2, various constraints 302 can define a configuration of the target system 201. These various constraints 302 can be stored and/or referenced at any suitable knowledge database accessible by the source code translating system 202. As illustrated, the constraints 302 can comprise, but are not limited to, calibration data, default parameters, vendor parameters, software type, software version, hardware type, hardware version, electronics mapping, code libraries, code languages, code versions, code syntax, and/or the like. Where the target system 201 is a quantum system, or where the source code is desired to be translated for a quantum computing related purpose, such as being a quantum source code, one or more quantum constraints 304 can comprise, but are not limited to, qubit coupling mapping, qubits to be employed, qubit performance metrics, pulse generator calibration data, quantum languages, quantum gates, vendor specific quantum syntax, and/or the like.

In one or more embodiments, various other quantum constraints that can define a configuration of a target system 201 being a quantum system can be back end configurations, back end defaults and/or backend properties. Backend configurations can comprise static information of a quantum device, such as backend_name, backend_version, n_qubits, basis_gates, dt, meas_levels, dtm, meas_map, or any other current or future basic configuration. Backend defaults can define a basic current configuration of the backend and can comprise information fields such as qubit_freq_est, meas_freq_est, buffer, pulse_library, cmd_def, meas_kernel, discriminator, data, or any other future information related. Backend properties can define a backend's performance gates, including which gates perform better, what are the coupling maps, or which qubits are better to use. Some fields included in this information can comprise gates, general, qubits.

Turning back again specifically to FIG. 2, the translation component can generally, based on the constraint defining the configuration, and/or based on plural constraints defining one or more configurations, translate the original source code 230 into the translated source code 240. This translation can comprise outputting a translated source code 240 comprising a code language, code syntax and/or code library not comprised by the original source code 230. Additionally and/or alternatively, this translation can comprise modification of the original source code 230 to align with the one or more constraints defining the configuration, which one or more constraints were identified by the identification component 212.

Turning briefly to both FIG. 3 and FIG. 2, a translated source code 240 can comprise one or more translation aspects 312 in view of the translation processes. The translation aspects 312 can comprise, and/or comprise use of, a different code language, code version, code library, code syntax, code style, and/or security parameters (e.g., as compared to the original source code 230), without being limited thereto.

Where the target system 201 is a quantum system, or where the source code is desired to be translated for a quantum computing related purpose, such as being a quantum source code, one or more quantum specific translation aspects 314 of a translated quantum source code 240 can any modification in the original source code that can produce a same result or an improved result. Examples of potential modifications can comprise change of qubits to use, change of gates, change of qubit mapping, change of quantum procedures to use, change of instructions or code statements to use, and addition of any improvement related to the desired hardware and constraints (noise, coupling maps, and/or the like), to the destination language, library, framework, etc., or any other code-related improvement (syntaxis, security, clarity, etc.), without being limiting. For example, the translated source code 240 can be tailored by the translation component 214 for use with one or more qubits, quantum logic circuits, couplings and/or the like that were not initially to be employed by the original (e.g., non-translated) quantum source code 230.

In one or more embodiments, the translation by the translation component 214 can be at least partially facilitated by an analytical model, such as the artificial intelligence model 216. An analytical model employed by the translation component 214 can comprise and/or can be comprised by a classical model, predictive model, neural network, and/or artificial intelligent model. An artificial intelligent model and/or neural network (e.g., a convolutional network and/or deep neural network) can comprise and/or employ artificial intelligence (AI), machine learning (ML), and/or deep learning (DL), where the learning can be supervised, self-supervised, semi-supervised and/or unsupervised.

For example, the artificial intelligence (AI) model 216 can employ and/or comprise a neural machine translation model that can learn equivalences between languages and/or how to translate the same features/functionality between languages. In one or more embodiments, the AI model 216 can learn, and/or access from a database, the particulars of an implementation designed for a specific target system and how to translate the source code considering specific constraints defining a configuration of the target system (e.g., target system 201). For example, for one target system, the AI model 216 can be trained as to changing the gates and qubits used, such as to adjust the code for one or more execution efficiencies on the one target system.

Generally, the AI model 216 can be trained, such as by the training component 220, on a set of training data that can represent the type of data for which the system will be used. Checks of the AI model 216, such as relative to new, conventional and/or popular configurations and/or constraints thereof, can be performed periodically and/or at any other frequency. Re-training of the AI model 216 can be performed employing up-to-date data collected from one or more knowledge databases, such as over a specified time window. For example, the training component 220 can train the AI model 216 upon determination of a new code language, new code library, altered quantum logic circuit, adjusted qubit coupling mapping and/or the like, not yet trained upon by the AI model 216.

In one or more embodiments, one or more translated source codes 240 can be evaluated against a quantum unit (e.g., executed at a quantum unit, such as at direction of the execution component 218, to be described below). In this way, a check can be provided of whether the translated source code functionality is accurate, efficient and/or the like and whether or not modifications resulting from the translation provide actual improvements to the execution of the source code or to a result of the execution of the source code. Further, an automatic code analysis can be run on a translated source code such as to evaluate if the code syntax, style and/or security, among other constraints, can be improved in the translations. Feedback from such checks and analyses can be automatically and/or manually transmitted to the training component 220, for example, for use in a future and/or immediate training of the AI model 216.

It is noted that the verification checks and/or feedback mentioned above likewise can be employed for non-quantum source code.

The execution component 218 can, in response to output of the translated source code 240 by the translation component 214, execute the translated source code 240 on the target system 201. As used herein, the execution can comprise direction of execution, e.g., transmission of a request and/or instruction, to execute the translated source code 240 on the target system 201.

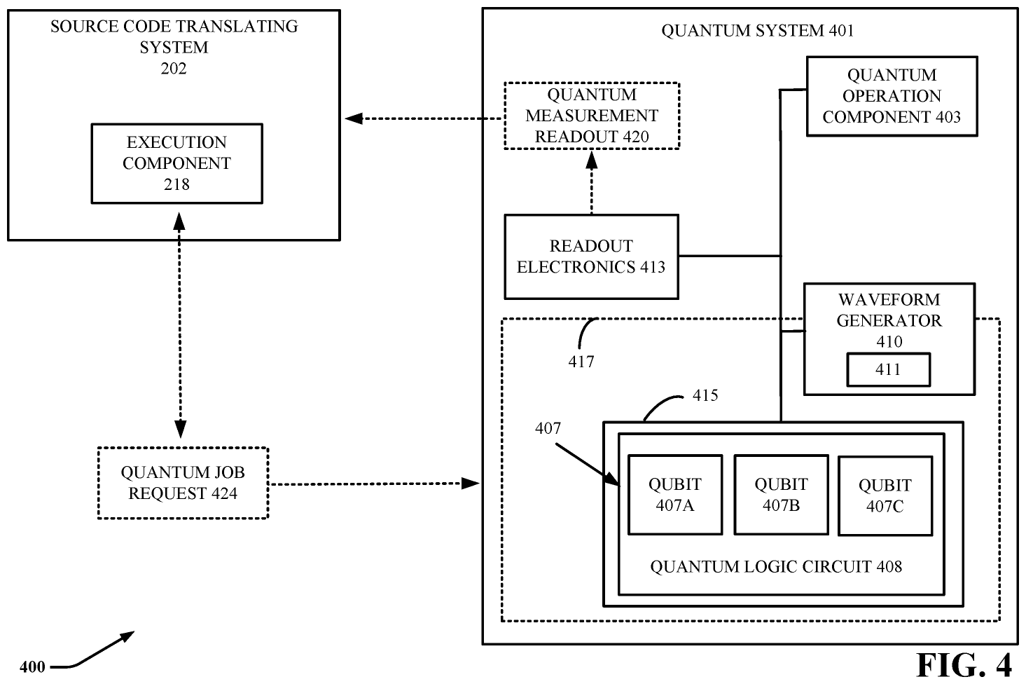

Turning now to FIG. 4, illustrated is a non-limiting system 400 comprising the source code translating system 202 and a quantum system 401. The source code translating system 202 can be employed to port and translate a quantum source code, such as where the original source code 230 is an original quantum source code, and where the translated source code 240 is a translated quantum source code. Indeed, where quantum systems continue to change, adapt and evolve, such as to include new processes, hardware and/or software, a user entity can still be able to execute an original source code at a target quantum system, such as the quantum system 401. For example, a user entity can write an original quantum source code that does not use the exact code syntax of the target quantum system. Additionally and/or alternatively, a user entity can write the original quantum source code assuming a different qubit coupling, or even different qubit performance metrics than as actually provided by/at the target quantum system. Yet, through use of the source code translating system 202, as described herein, that user entity's original quantum source code still can be ported and translated (e.g., modified) for use with one or more constraints (e.g., the different qubit coupling and/or qubit performance metrics) of the target quantum system (e.g., quantum system 401).

In one or more embodiments, the non-limiting system 400 can be a hybrid system and thus can include both a quantum system and a classical system, such as the quantum system 401 and a classical-based system (also herein referred to as a classical system, such as the source code translating system 202). In one or more embodiments, one or more components of the classical system can be at least partially comprised by the quantum system 401, or otherwise comprised external to the classical system. In one or more embodiments, the source code translating system 202 and/or one or more components thereof can be comprised by the quantum system 401. In one or more embodiments, one or more components of the quantum system 401, such as the readout electronics 413, can be at least partially comprised by a classical system, or otherwise disposed external to the quantum system 401.

One or more communications between one or more components of the non-limiting system 400 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The source code translating system 202 and/or the quantum system 401 can be associated with, such as accessible via, a cloud computing environment. For example, the source code translating system 202 can be associated with a cloud computing environment such that aspects of classical processing can be distributed between the source code translating system 202 and the cloud computing environment.

Turning now to the quantum system 401, generally based on a quantum job request 424, such as comprising a quantum circuit to be executed, the quantum operation component 403 and/or quantum processor 406 can direct execution of the quantum circuit at the quantum logic circuit 408. In one or more embodiments, the quantum job request 424 can comprise the translated quantum source code 240. In one or more embodiments, the execution component 218 of the source code translating system 202 can output the quantum job request 424, such as to direct execution of the translated quantum source code 240, comprised by the quantum job request 424, at the quantum system 401.

Generally, the quantum system 401 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 420, can be responsive to the quantum job request 424 and associated input data and can be based at least in part on the input data, quantum functions and/or quantum computations.

In one or more embodiments, the quantum system 401 can comprise components, such as a quantum operation component 403, a quantum processor 406, pulse component 410 (e.g., a waveform generator) and/or the readout electronics 413. The quantum processor 406 can comprise the quantum logic circuit 408 comprising one or more, such as plural, qubits 407. Individual qubits 407A, 407B and 407C, for example, can be fixed frequency and/or single junction qubits, such as transmon qubits.

As used herein, a quantum circuit can be a set of operations, such as gates, performed on a set of real-world physical qubits with the purpose of obtaining one or more qubit measurements. A quantum processor can comprise the one or more real-world physical qubits.

The quantum processor 406 can be any suitable processor. The quantum processor 406 can generate one or more instructions for controlling the one or more processes of the quantum operation component 403 and/or for controlling the quantum logic circuit 408.

The quantum operation component 403 can obtain (e.g., download, receive, search for and/or the like) a quantum job request 424 requesting execution of one or more quantum programs and/or a physical qubit layout. The quantum job request 424 can be provided in any suitable format, such as a text format, binary format and/or another suitable format.

The quantum operation component 403 can determine one or more quantum logic circuits for executing a quantum program. In one or more embodiments, the quantum operation component 403 and/or quantum processor 406 can direct the waveform generator 410 to generate one or more pulses 411, tones, waveforms and/or the like to affect one or more qubits 407.

That is, operation of the quantum circuit can be supported, such as by a pulse component (also herein referred to as a waveform generator), to produce one or more physical pulses and/or other waveforms, signals and/or frequencies to alter one or more states of one or more of the physical qubits. The altered states can be measured, thus allowing for one or more computations to be performed regarding the qubits and/or the respective altered states.

The waveform generator 410 can generally perform one or more quantum processes, calculations and/or measurements for shifting the frequency of one or more qubits 407, such as when in respective excited states. For example, the waveform generator 410 can operate one or more qubit effectors, such as qubit oscillators, harmonic oscillators, pulse generators and/or the like to cause one or more pulses to stimulate and/or manipulate the state(s) of the one or more qubits 407 comprised by the quantum system 401.

The quantum logic circuit 408 and a portion or all of the waveform generator 410 can be contained in a cryogenic environment, such as generated by a cryogenic chamber 417, such as a dilution refrigerator. Indeed, a signal can be generated by the waveform generator 410 to affect one or more of the plurality of qubits 407. Where the plurality of qubits 407 are superconducting qubits, cryogenic temperatures, such as about 4 Kelvin (K) or lower can be employed for function of these physical qubits. Accordingly, one or more elements of the readout electronics 413 also can be constructed to perform at such cryogenic temperatures.

The readout electronics 413, or at least a portion thereof, can be contained in the cryogenic chamber 417, such as for reading a state, frequency and/or other characteristic of qubit, excited, decaying or otherwise.

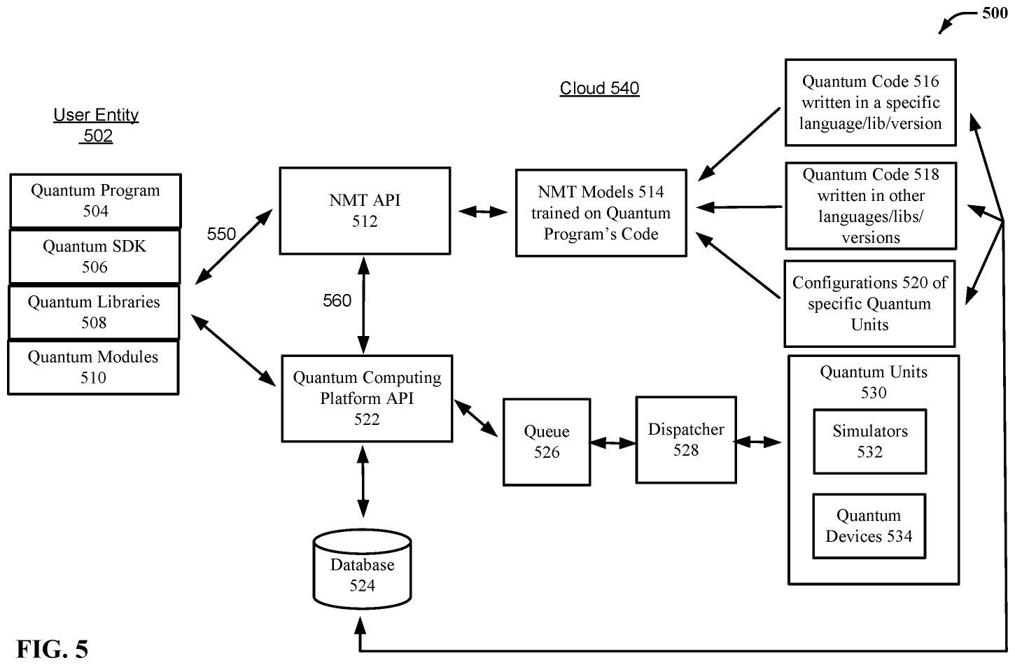

Looking next briefly to FIG. 5, illustrated is a schematic 500 comprising a user entity 502 and a cloud 540. As mentioned above, one or more processes of a source code translating system described herein can be operated in the cloud. Additionally and/or alternatively, one or more components of a source code translating system described herein can be located and/or operate relative to a cloud. Repetitive description of like elements and/or processes employed in respective embodiments is omitted for sake of brevity. Description relative to an embodiment of FIG. 5 can be applicable to an embodiment of FIG. 2. Likewise, description relative to an embodiment of FIG. 2 can be applicable to an embodiment of FIG. 5.

The schematic 500 presents a flow of one or more aspects that can be performed and/or used by a source code translating system described herein, such as the source code translating system 202, relative to an original quantum source code that is desired to be executed at a target quantum system, such as comprising the quantum units 530, simulators 532 and/or quantum devices 534.

For example, relative to the schematic 500, a user entity 502 can comprise various quantum programs 504, quantum software development kits (SDKs), quantum libraries 508 and/or quantum modules 510. As used herein, a quantum module can be a set of code methods and/or procedures that can be custom and/or from a third party that are not part of a library and/or SDK and can be used to write a user entity's program(s).

After submission of an original source code, such as an original quantum source code at 550, the NMT application programming interface (API) 512, such as comprised by and/or comprising a source code translating system described herein, can translate the original quantum source code. Indeed, the NMT API 512 can translate the original quantum source code employing one or more NMT models 514 (e.g., artificial intelligence model 216) that have been trained on code of a quantum program that runs and/or is executed on a particular quantum unit 530. As shown, the NMT models 514 can be trained (e.g., by a suitable training component) on quantum code 516 written in a specific language, with a particular library, or for a particular code version (language/lib/version), and/or on quantum code 518 from other languages/libs/versions. Furthermore, configurations 520 of one or more of the quantum units 530 can be employed by the NMT models 514 to align the original source code with the target quantum system (e.g., one or more components of the quantum units 530). In one or more embodiments, a database 524 can comprise any one or more languages, libraries, versions and/or configurations 520.

Upon translation, the NMT API 512 can output at 560 the translated quantum source code to a suitable quantum computing platform API 522, such as in connection with one or more of the quantum units 530. After making its way through a queue 526 and to a suitable dispatcher 528, the translated quantum source code can be executed on one or more quantum units 530.

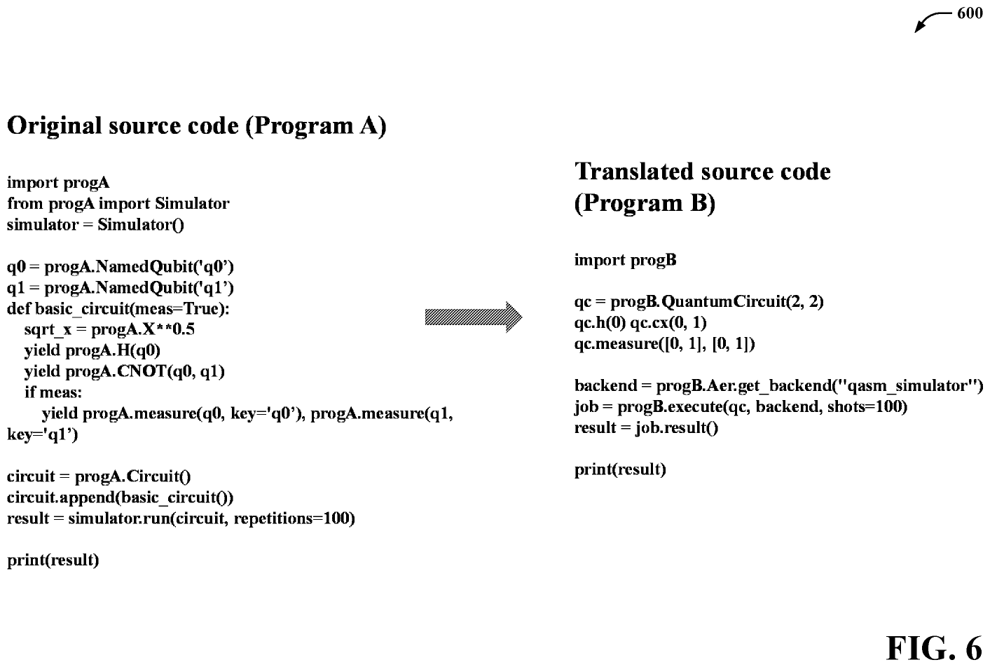

Turning now to FIG. 6, illustrated is an illustration 600 comprising an example translation of an original quantum source code written in a Program A (progA) that is translated into a translated quantum source code for use with a Program B (progB) at a quantum device. Program B can use a different code language, code library and/or code syntax, without being limited, as compared to Program A. The translation can be facilitated by a source code translating system described herein.

For example, Program A source code can define a basic quantum circuit written using Program A comprising a function to add two quantum gates (H and CNOT) and a measurement. The Program A source code also can comprise related instructions to instantiate the qubits to finally declare how to run the circuit in a quantum simulator and output the result. Program B source code is a translated version of the original Program A source code to which the AI model (e.g., AI model 216) has converted to utilize Program B and to define the same quantum circuit using Program B instructions. After determining the quantum circuit, the AI model can add the quantum gates (H and CNOT) and a measurement using Program B methods and can define how to run the code in a quantum simulator to output the result at the end. As illustrated, an AI model, such as employing NMT, has generated a translated Program B source code and has removed the internal function basic_circuit( ) from the original Program A source code since this internal function is not strictly employed to reproduce the execution behavior of the original Program A source code.

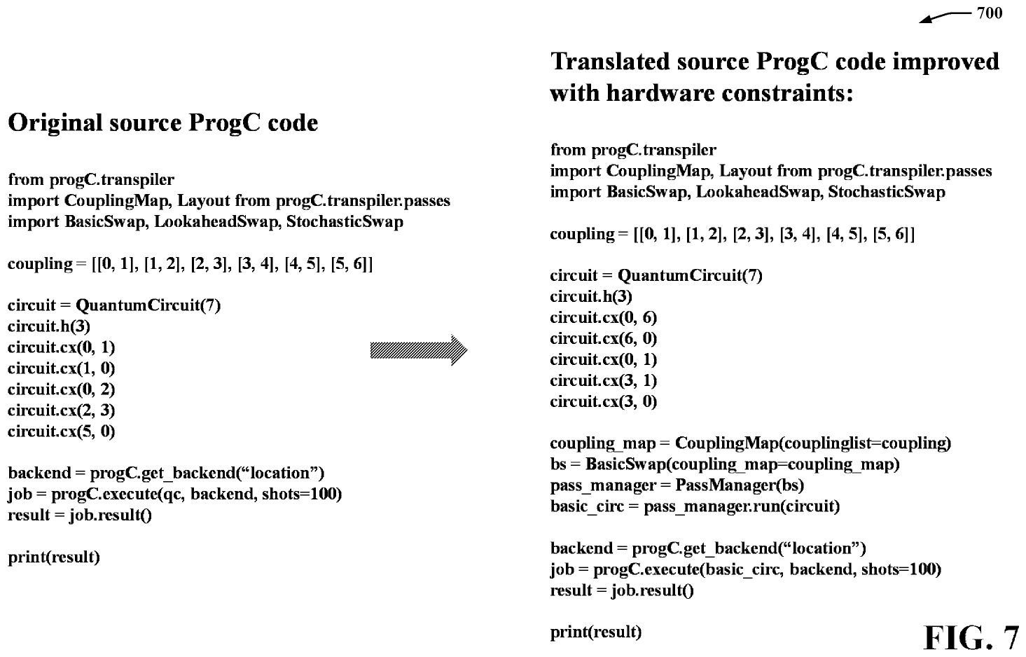

Turning now to FIG. 7, illustrated is an illustration 700 comprising an example translation of an original quantum source code written in a Program C (progC) that is translated into a translated quantum source code for use with a same Program c (progC). While the same code language, code library and/or code syntax can be employed for each of the original quantum source code and the translated quantum source code, the translation to the translated quantum source code can comprise modification, such as for adjusting coupling mapping, changing quantum gates, changing qubits used, changing to better performant qubits, and/or the like. The translation can be facilitated by a source code translating system described herein.

For example, the original Program C source code can define a quantum circuit, and applies the quantum circuit to a set of gates to, ultimately, run the quantum circuit in a quantum backend (unit) and gather the result to output the result, but can comprise an unused coupling map for a quantum unit. In the improved translated Program C source code, the AI model, such as employing NMT, can have defined the same coupling map and circuit while considering the quantum unit which is going to run the program. The translated Program C source code can be written to employ a previously undefined coupling map (e.g., previously undefined at the original Program C source code), running several transpilation and optimization passes (BasicSwap, PassManager), to generate an improved quantum circuit tailored for the target quantum system at which the original Program C source code was desired to be run, and at which the translated Program C source code is to be run. That is, the translated Program C source code can comprise and/or can comprise instructions for a tailored (e.g., transpiled and/or optimized) quantum circuit for execution at the target quantum system.

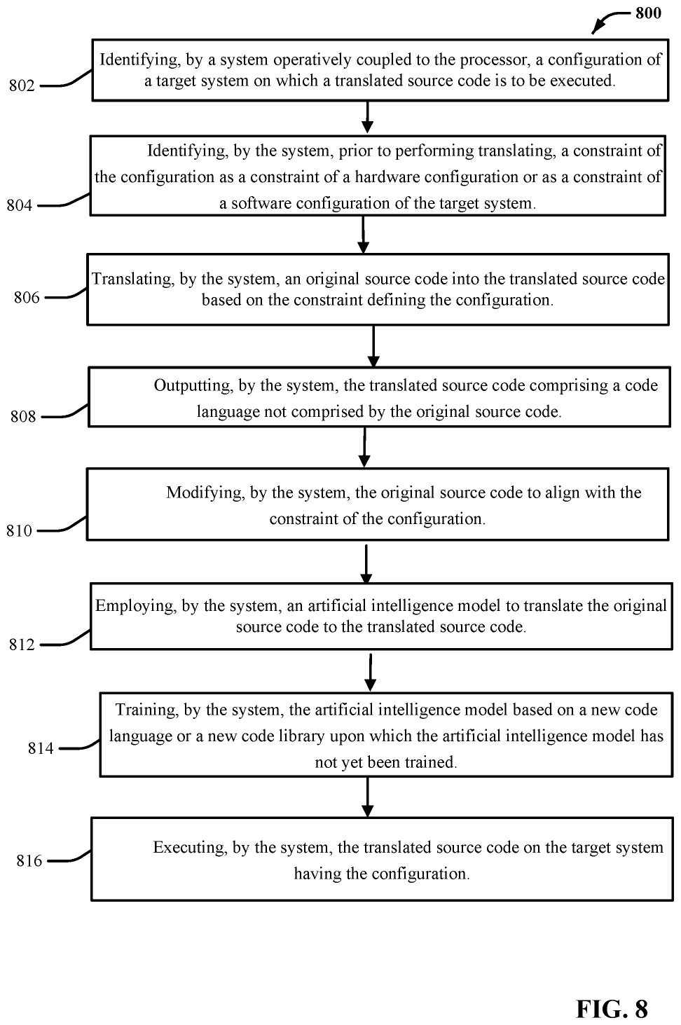

Referring next to FIG. 8, illustrated is a flow diagram of an example, non-limiting method 800 that can provide a process to port and translate an original source code for execution at a target system, in accordance with one or more embodiments described herein, such as the non-limiting system 200 of FIG. 2. While the non-limiting method 800 is described relative to the non-limiting system 200 of FIG. 2, the non-limiting method 800 can be applicable also to other systems described herein, such as the non-limiting system 100 of FIG. 1. Repetitive description of like elements and/or processes employed in respective embodiments is omitted for sake of brevity.

At 802, the non-limiting method 800 can comprise identifying, by a system operatively coupled to the processor (e.g., identification component 212), a configuration of a target system on which a translated source code is to be executed.

At 804, the non-limiting method 800 can comprise identifying, by the system (e.g., identification component 212) prior to performing translating, a constraint of the configuration as a constraint of a hardware configuration or as a constraint of a software configuration of the target system.

At 806, the non-limiting method 800 can comprise translating, by the system (e.g., translation component 214), an original source code into the translated source code based on the constraint defining the configuration.

At 808, the non-limiting method 800 can comprise outputting, by the system (e.g., translation component 214), the translated source code comprising a code language not comprised by the original source code.

At 810, the non-limiting method 800 can comprise modifying, by the system (e.g., translation component 214), the original source code to align with the constraint of the configuration.

At 812, the non-limiting method 800 can comprise employing, by the system (e.g., translation component 214), an artificial intelligence model (e.g., artificial intelligence model 216) to translate the original source code to the translated source code.

At 814, the non-limiting method 800 can comprise training, by the system (e.g., training component 220), the artificial intelligence model based on a new code language or a new code library upon which the artificial intelligence model has not yet been trained.

At 816, the non-limiting method 800 can comprise executing, by the system (e.g., execution component 222), the translated source code on the target system having the configuration. As used herein, the execution can comprise the direction of the execution of the translated source code on a target system, such as the target system 201.

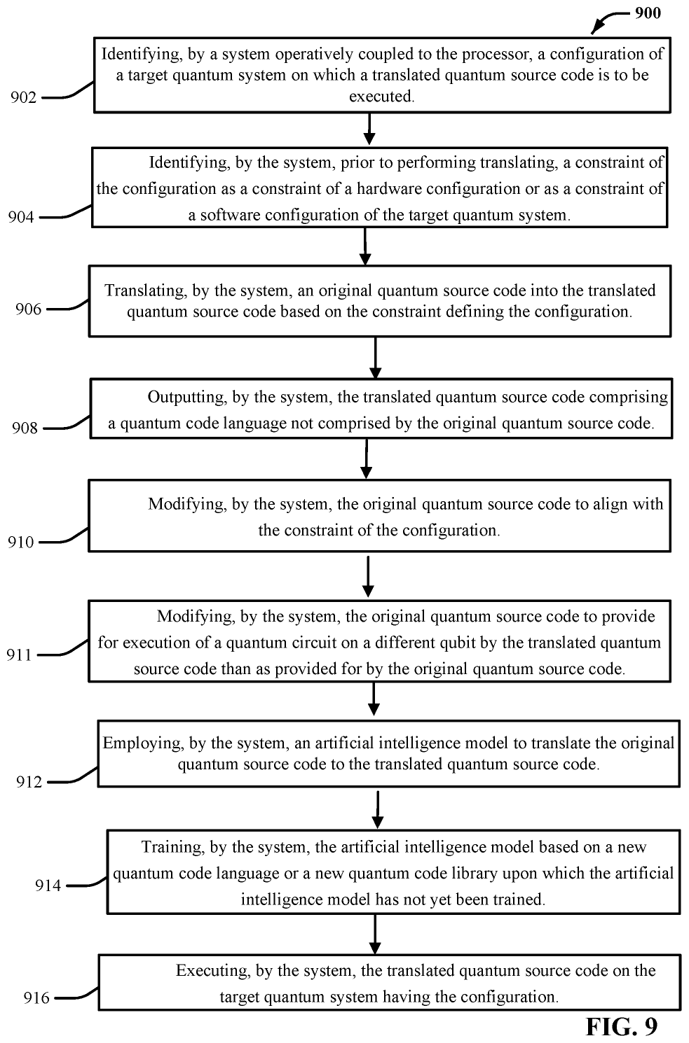

Referring next to FIG. 9, illustrated is a flow diagram of an example, non-limiting method 900 that can provide a process to port and translate an original quantum source code for execution at a target quantum system, in accordance with one or more embodiments described herein, such as the non-limiting system 200 of FIG. 2. While the non-limiting method 900 is described relative to the non-limiting system 200 of FIG. 2, the non-limiting method 900 can be applicable also to other systems described herein, such as the non-limiting system 100 of FIG. 1. Repetitive description of like elements and/or processes employed in respective embodiments is omitted for sake of brevity.

At 902, the non-limiting method 900 can comprise identifying, by a system operatively coupled to the processor (e.g., identification component 212), a configuration of a target quantum system on which a translated quantum source code is to be executed.

At 904, the non-limiting method 900 can comprise identifying, by the system (e.g., identification component 212) prior to performing translating, a constraint of the configuration as a constraint of a hardware configuration or as a constraint of a software configuration of the target quantum system.

At 906, the non-limiting method 900 can comprise translating, by the system (e.g., translation component 214), an original quantum source code into the translated quantum source code based on the constraint defining the configuration.

At 908, the non-limiting method 900 can comprise outputting, by the system (e.g., translation component 214), the translated quantum source code comprising a quantum code language not comprised by the original quantum source code.

At 910, the non-limiting method 900 can comprise modifying, by the system (e.g., translation component 214), the original quantum source code to align with the constraint of the configuration.

At 911, the non-limiting method 900 can comprise modifying, by the system (e.g., translation component 214) the original quantum source code to provide for execution of a quantum circuit on a different qubit by the translated quantum source code than as provided for by the original quantum source code.

At 912, the non-limiting method 900 can comprise employing, by the system (e.g., translation component 214), an artificial intelligence model (e.g., artificial intelligence model 216) to translate the original quantum source code to the translated quantum source code.

At 914, the non-limiting method 900 can comprise training, by the system (e.g., training component 220), the artificial intelligence model based on a new quantum code language or a new quantum code library upon which the artificial intelligence model has not yet been trained.

At 916, the non-limiting method 900 can comprise executing, by the system (e.g., execution component 222), the translated quantum source code on the target quantum system having the configuration. As used herein, the execution can comprise the direction of the execution of the translated quantum source code on a target quantum system, such as the quantum system 401.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, devices, computer program products and/or computer-implemented methods of use provided herein relate to a process to port code while adapting the code for a configuration of a target system. A system can comprise a memory that stores computer executable components, and a processor that executes the computer executable components stored in the memory, wherein the computer executable components can comprise an identification component that identifies a configuration of a target system on which a translated source code is to be executed, and a translation component that translates, based on a constraint defining the configuration, an original source code into the translated source code. In one or more embodiments, the translated source code can comprise a code language not comprised by the original source code and/or can be modified to align with the constraint, which can be of a hardware and/or software configuration.

An advantage of the above-indicated method can be allowing for various source code languages, versions, syntax and/or libraries to be used in connection with a same target system. Additionally, and/or alternatively, where the translation comprises modification of the source code, such modification can reduce execution cost, such as time, power usage and/or memory usage, associated with execution of a hardware and/or software component of the target system.

The translation can allow for better performance and/or measurement results from a hardware and/or software component of the target system on which the translated source code is to be executed. In this way, the translation can be efficient and can aid in preparing the original source code, as a translated source code, for efficient and high performance execution on the target system. Furthermore, where code libraries and languages continue to change, evolve, and be written, a user entity can still obtain execution of an original source code, even without knowing and/or being trained on all particulars of source code used by a target system.

Indeed, in view of the one or more embodiments described herein, a practical application of the systems, computer-implemented methods and/or computer program products described herein can be ability to translate an original source code into a translated source code for use on a target system, where the original source code would have been unable to be used or unable to be used well on the target system due to lack of alignment to a configuration of the target system. Such is a useful and practical application of computers, thus providing enhanced (e.g., improved and/or optimized) operation of the hardware and/or software components of the target system (e.g., having the configuration for which the translated source code has been aligned). Overall, such computerized tools can constitute a concrete and tangible technical improvement in the field of source coding and source code execution.

Furthermore, where a translated source code is a translated quantum source code, the translation can be a useful and practical application of computers, thus providing enhanced (e.g., improved and/or optimized) operation of a quantum logic circuit of a target quantum system. Overall, such computerized tools can constitute a concrete and tangible technical improvement in the field of source coding and source code execution relative to quantum computing.

Furthermore, one or more embodiments described herein can be employed in a real-world system based on the disclosed teachings. For example, one or more embodiments described herein can function with a quantum system that can receive as input a quantum job request comprising a quantum source code having been translated by a source code translating system as described herein, and can measure a real-world qubit state of one or more qubits, such as superconducting qubits, of the quantum system, by executing the translated quantum source code at some level of the quantum system.

Moreover, a device and/or method described herein can be implemented in one or more domains to enable scaled source code translations. Indeed, use of a system as described herein can be scalable, such as where plural original source codes can be translated at least partially at a same time as one another. The plural source codes can be translated for use at a same target system or different target systems. Additionally and/or alternatively, an original source code can be translated in various iterations, at least partially at a same time as one another, for use at a same target system or different target system.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to source code translation, as compared to existing systems and/or techniques. Systems, computer-implemented methods and/or computer program products providing performance of these processes are of great utility in the fields of source code execution, such as in connection with quantum computing and superconducting quantum systems, and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically translate an original source code for alignment with a configuration of a target system as the one or more embodiments described herein can provide this process. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the source code translating code 2000. In addition to block 2000, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 2000, as identified above), peripheral device set 1014 (including user interface (UI), device set 1023, storage 1024, and Internet of Things (IOT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 2000 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 2000 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

1. A system, comprising:
a memory that stores computer executable components; and
a processor that executes the computer executable components stored in the memory, wherein the computer executable components comprise:
an identification component that identifies a configuration of a target system on which a translated source code is to be executed; and
a translation component that translates, based on a constraint defining the configuration, an original source code into the translated source code.

2. The system of claim 1, wherein the translated source code comprises a code language not comprised by the original source code.

3. The system of claim 1, wherein the translation performed by the translation component comprises modifying the original source code to align with the constraint of the configuration.

4. The system of claim 1, wherein the identification component further identifies, prior to the translation, the constraint of the configuration as a constraint of a hardware configuration or as a constraint of a software configuration.

5. The system of claim 1, further comprising:
an execution component that executes the translated source code on the target system having the configuration.

6. The system of claim 1, further comprising:
an artificial intelligence model employed by the translation component to translate the original source code to the translated source code.

7. The system of claim 6, further comprising:
a training component that trains the artificial intelligence model based on a new code language or a new code library upon which the artificial intelligence model has not yet been trained.

8. A computer-implemented method, comprising:
identifying, by a system operatively coupled to a processor, a configuration of a target system on which a translated source code is to be executed; and
translating, by the system, an original source code into the translated source code based on a constraint defining the configuration.

9. The computer-implemented method of claim 8, wherein the translated source code comprises a code language not comprised by the original source code.

10. The computer-implemented method of claim 8, wherein the translating comprises modifying, by the system, the original source code to align with the constraint of the configuration.

11. The computer-implemented method of claim 8, further comprising:
identifying, by the system, prior to performing the translating, the constraint of the configuration as a constraint of a hardware configuration or as a constraint of a software configuration.

12. The computer-implemented method of claim 8, further comprising:
executing, by the system, the translated source code on the target system having the configuration.

13. The computer-implemented method of claim 8, further comprising:
employing, by the system, an artificial intelligence model to translate the original source code to the translated source code.

14. The computer-implemented method of claim 13, further comprising:
training, by the system, the artificial intelligence model based on a new code language or a new code library upon which the artificial intelligence model has not yet been trained.

15. A computer program product facilitating a process to automatically port source code, the computer program product comprising a computer readable storage medium having program instructions embodied therewith, the program instructions executable by a processor to cause the processor to:
identify, by the processor, a configuration of a target system on which a translated source code is to be executed; and
translate, by the processor, based on a constraint defining the configuration, an original source code into the translated source code.

16. The computer program product of claim 15, wherein the translated source code comprises a code language not comprised by the original source code.

17. The computer program product of claim 15, wherein the program instructions are further executable by the processor to cause the processor to:
modify, by the processor, the original source code to align with the constraint of the configuration.

18. The computer program product of claim 15, wherein the program instructions are further executable by the processor to cause the processor to:
identify, by the processor, prior to performing the translating, the constraint of the configuration as a constraint of a hardware configuration or as a constraint of a software configuration.

19. The computer program product of claim 15, wherein the program instructions are further executable by the processor to cause the processor to:
employ, by the processor, an artificial intelligence model to translate the original source code to the translated source code.

20. The computer program product of claim 19, wherein the program instructions are further executable by the processor to cause the processor to:
train, by the processor, the artificial intelligence model based on a new code language or a new code library upon which the artificial intelligence model has not yet been trained.
